(19) United States
(12) Patent Application Publication
(10) Pub. No.: US 2017/0270787 A1
(43) Pub. Date: Sep. 21, 2017

(54) SYSTEM AND METHOD FOR ROADSIDE ALERTS

(71) Applicant: Timothy Shaun Menard, Mountain View, CA (US)

(72) Inventor: Timothy Shaun Menard, Mountain View, CA (US)

(21) Appl. No.: 15/075,422

(22) Filed: Mar. 21, 2016

(51) Int. Cl. G08G 1/0967

(52) U.S. Cl. CPC G08G 1/096783

(57) ABSTRACT

A roadside alert system includes at least one processor and at least one memory architecture coupled with the at least one processor configured to perform operations including, detecting at a Road-Side Unit (RSU) a vehicle, transmitting an alert from the RSU, upon detecting the vehicle, to a mobile computing device associated with the vehicle, and allowing communication between one of, the RSU, the mobile computing device, and a roadside infrastructure communication network. The roadside infrastructure communication network includes a roadside infrastructure network database located on a server and on a mobile computing device, wherein the roadside infrastructure database includes a lookup table.

### TECHNICAL FIELD

This disclosure relates to Road-Side Units (RSU), and more particularly, to transmitting a roadside alert from the RSU to a mobile computing device, wherein the mobile computing device is associated with a vehicle or a person.

### BACKGROUND

This section is intended to provide a discussion of the related art, and to facilitate an understanding of various technologies described herein. That such art is related in no way implies that it is prior art. It should therefore be understood that the statements in this section are to be read in this light, and not as admissions of prior art.

Traffic devices, such as traffic signs have long been used to alert drivers of the presence of regulatory data pertaining to a geographical location. These traffic signs have typically been placed roadside, and alert drivers to this regulatory data only when drivers see these traffic signs. A need therefore exists for a more efficient system of alerting drivers to the presence of regulatory data.

### BRIEF SUMMARY OF DISCLOSURE

In a first implementation, a roadside alert system includes at least one processor, and at least one memory architecture coupled with the at least one processor, wherein the at least one processor is configured to perform operations, which may include, but are not limited to, the detection of a vehicle at a Road-Side Unit (RSU). The system may allow for the transmission of an alert from the RSU, upon detection of the vehicle, to a mobile computing device associated with the vehicle. The system may allow for communication between one of, the RSU, the mobile computing device, and a roadside infrastructure communication network, wherein the roadside infrastructure communication network may include a roadside infrastructure network database located on a server.

One or more of the following features may be included. The transmission of an alert may include the configuration of a wireless antenna beam pattern, and the programming of a transmit power level. The system may allow for configuration of the RSU based, at least in part, upon one of, environmental data, regulatory data, hazard and congestion warning data, data pertaining to one or more geographical locations, and data pertaining to the vehicle. The system may monitor one or more sensor(s), wherein the one or more sensor(s) may be configured to collect roadside data and vehicle data. The system may receive roadside data, and vehicle data, from at least one of, the one or more sensor(s), the mobile computing device, and the roadside infrastructure communication network.

The system may further allow for the generation of a mobile computing device message. The mobile computing device message may be transmitted to the RSU. Further, the mobile computing device message may be transmitted periodically to the RSU, wherein the mobile computing device may be one of, a mobile phone, an in-dash vehicle information console, and a dedicated roadside alert device. The system may allow for the mobile computing device to receive the alert, process the alert, and display the alert.

In another implementation, a Road-Side Unit (RSU) includes a processor, a non-transient computer readable medium, a vehicle detection device, one or more sensor(s), and a wireless transmitter. The one or more sensor(s) may be configured to collect roadside data and vehicle data. The wireless transmitter may be configured to deliver a roadside alert to a mobile computing device associated with the vehicle.

One or more of the following features may be included. The vehicle detection device may be configured to be passive in operation. The wireless transmitter may include a configurable wireless antenna beam pattern, and a programmable transmit power level. The RSU may be coupled to a roadside infrastructure network, wherein the roadside infrastructure network includes a roadside infrastructure database. The roadside infrastructure database may be located on a server and on the mobile computing device, and may include a lookup table. The RSU may further include one or more receivers, and the one or more receivers may be configured to receive roadside data, Global Positioning System (GPS) data and vehicle data.

The RSU may further include a programming interface, which may allow the RSU to be configured. The RSU may be associated with a PCBA (Printed Circuit Board Assembly), and the PCBA may be incorporated into a sign. An antenna reflector may be associated with the sign, and may be configured as a quarter wavelength antenna reflector. The PCBA may be encapsulated in a weatherproof enclosure, wherein the weatherproof enclosure may be configured to be attached to an existing sign or located a notification distance from the existing sign.

In another implementation, a computer-implemented method includes detecting a vehicle at a Road-Side Unit (RSU). One or more implementations may include, energizing the RSU based, at least in part, upon detecting the vehicle. The method may allow for the transmitting of an alert from the RSU to a mobile computing device, wherein the mobile computing device may be associated with the vehicle. The transmitted alert may be based, at least in part, upon environmental data, regulatory data, hazard and congestion warning data, which may pertain to one or more geographical locations, and may include data pertaining to the vehicle. The transmitting of the alert may include configuring a wireless antenna beam pattern, and the programming of a transmit power level.

One or more of the following features may be included. The allowing of communication between one of, the RSU, the mobile computing device, and a roadside infrastructure communication network, wherein the roadside infrastructure communication network may include a roadside infrastructure network database. The roadside infrastructure database may be located on a server and on the mobile computing device, and may include a lookup table.

Further, the method may include the monitoring one or more sensor(s), wherein the one or more sensor(s) are configured to collect roadside data and vehicle data. The method may also include the receiving of roadside data, and vehicle data, from at least one of, the one or more sensor(s), the mobile computing device, and the roadside infrastructure communication network. The mobile computing device may be one of, a mobile phone, an in-dash vehicle information console, and a dedicated roadside alert device. The method may also include the mobile computing device receiving the alert, processing the alert, and displaying the alert.

The details of one or more implementations are set forth in the accompanying drawings and the description below. Other features and advantages will become apparent from the description, the drawings, and the claims.

### BRIEF DESCRIPTION OF THE DRAWINGS

Implementations of various techniques directed to an apparatus, a system and method relating to a Road-Side Unit (RSU), and an alert process, will hereafter be described with reference to the accompanying drawings. It should be understood, however, that the accompanying drawings illustrate only the various implementations described herein, and are not meant to limit the scope of the various techniques described herein.

FIG. 1 is an illustrative diagrammatic view of an alert process coupled to a distributed computing network, according to one or more implementations of the present disclosure;

FIG. 2 is an illustrative diagrammatic view of a Road-Side Unit (RSU) of FIG. 1, according to one or more implementations of the present disclosure;

FIG. 3 is an illustrative diagrammatic view of RSU, wherein the RSU is integrated into a sign, according to one or more implementation of the present disclosure;

FIG. 4 is an illustrative diagrammatic view of RSU transmission zones, according to one or more implementations of the present disclosure;

FIG. 5 is an illustrative flowchart of the alert process of FIG. 1, according to one or more implementations of the present disclosure;

FIG. 6 is an illustrative diagrammatic view of an alert message structure, according to one or more implementations of the present disclosure;

FIG. 7 is an illustrative diagrammatic view of a RSU state machine, according to one or more implementations of the present disclosure; and

FIG. 8 is an illustrative diagrammatic view of a mobile computing device state machine, according to one or more implementations of the present disclosure;

Like reference symbols in the various drawings may indicate like elements.

### DETAILED DESCRIPTION

### System Overview:

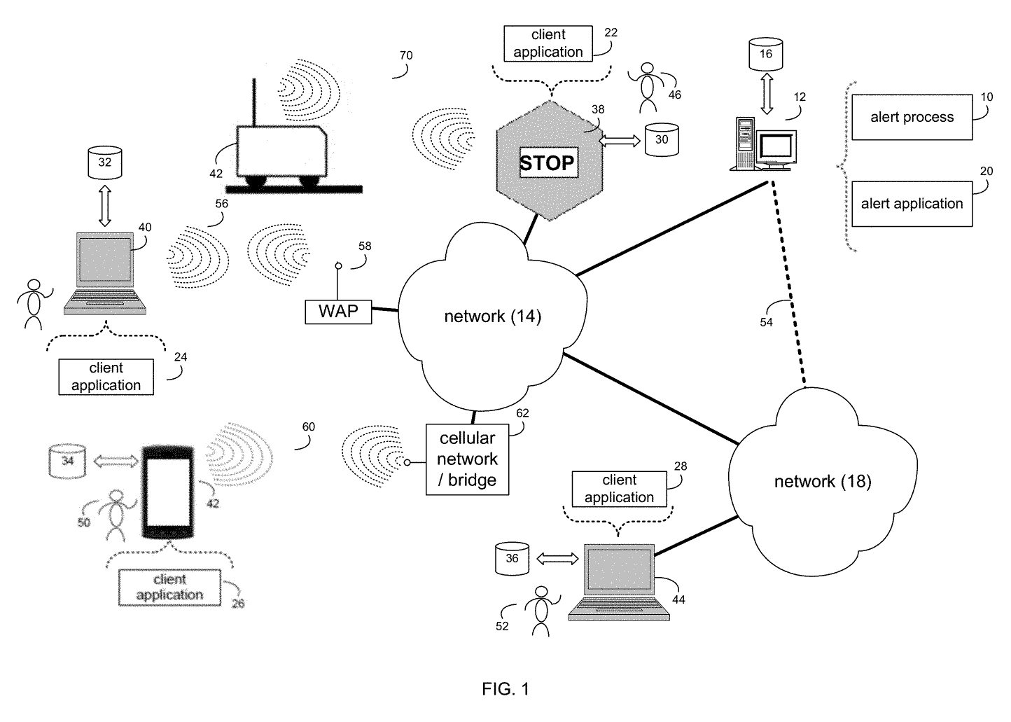

Referring to FIG. 1, there is shown an alert process 10 that may reside on a microprocessor(s) (not shown) within a Road-Side Unit (RSU) 42, or may be executed by a discrete computer 12. Examples of discrete computer 12 may include, but are not limited to, a personal computer(s), a laptop computer(s), a mobile computing device(s) 42, a server computer, a series of server computers, a mainframe computer(s), or a computing cloud(s). The RSU 42 and/or discrete computer 12 may be connected to a network 14, wherein the network 14 may be the internet or a local area network.

While RSU 42 may be depicted in FIG. 1, and throughout the disclosure as being associate with a network 14, wherein network 14 may be the internet or a local area network, this is intended to be for illustrative purposes only. The RSU 42 may or may not be connected to the internet or a local area network. For example, network 14 described below as being as a roadside infrastructure network may include, but is not limited to, a Roadside to Vehicle (R2V) network, the internet, a local area network, etc., or combination thereof. Therefore, the roadside infrastructure network may be any appropriate communication network that allows communication between a plurality of microprocessors and/or computers within the roadside alert system.

The alert process 10, may include situating 510 the RSU 42 at a given location, wherein the location may be, for example, a roadside intersection (not shown). The alert process 10 may further include, detecting 540 a vehicle 42 or mobile computing device 42 associated with the vehicle 42. The alert process 10 may further include the RSU 42 transmitting 560 an alert, wherein the alert may pertain one or more of, environmental data, regulatory data, hazard and congestion warning data, wherein the aforementioned data may pertain to one or more geographical locations.

While the mobile computing device 42 is depicted in FIG. 1, and throughout the disclosure as being and/or associated with a vehicle 42, and thereby by implication proximate to a road, this is intended to be for illustrative purposes only. The mobile computing device 42 may be associated with any mobile object, for example, automobile(s), construction equipment, bicycle(s), vessel(s), airplane(s), train(s) or person. Therefore the RSU 38 may be located at any geographical location where an alert message is appropriate.

Further, the mobile computing device 42 may be any mobile computing device 42, for example a mobile phone, an in-dash vehicle information console, or a standalone roadside alert device with similar utility to that of a standalone GPS unit, wherein the mobile computing device 42 is capable of receiving 570 the alert, decoding 580 the alert, and displaying 590 the alert.

Furthermore; while the RSU 38 is depicted in FIG. 1, and throughout the disclosure as being associated with a “STOP” sign 312, and therefore the alert as being for a “STOP” sign 312, this is intended to be for illustrative purposes only. The RSU 38 may associated with any sign 312, for example, road signs, billboards, business advertisements, signal and road markings, including “YIELD”, “STOP”, traffic lights, speed limits, construction, highway alert signs, including alphanumeric highway alert signs, pedestrian, school zones, construction zones, including construction workers, signage, hazard markers, including cones, barricades, emergency services and personal, animals, including horses, individuals including crossing guards and construction workers, bicycles, traffic signals and crossbucks. Therefore the alert may, for example, be associated with, and therefore based, at least in part, upon environmental data, regulatory data, hazard and congestion warning data, pertaining to one or more geographical locations.

As will be discussed below in greater detail, alert process 10 may define the situating 510 of the RSU 38, the configuring 520 of the RSU 38, the detection 540 of a vehicle 42 by the RSU 38, the transmission 560 of an alert by the RSU, the receiving 570 of the alert by a mobile computing device 42, the decoding 580 of the alert by the mobile computing device 42, and the displaying 590 of the alert by the mobile computing device 42.

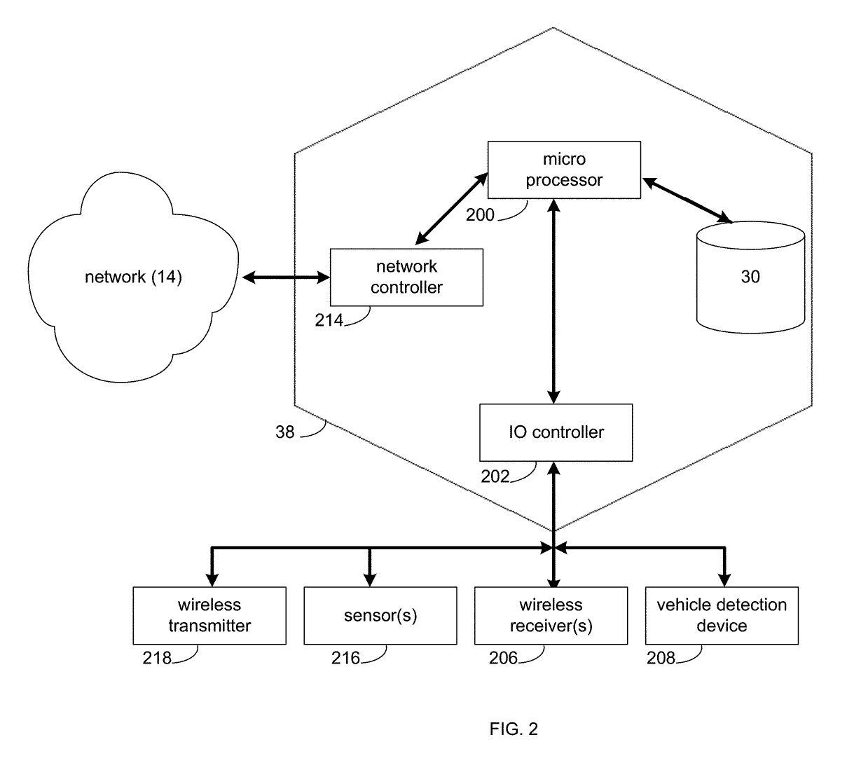

Referring also to FIG. 2, there is shown a diagrammatic view of a Road-Side Unit (RSU) 38. While a RSU 38 is shown in this figure, this is for illustrative purposes only, and is not intended to be a limitation of this disclosure, as other configurations are possible. For example, any computing device capable of executing, in whole or in part, alert process 10 may be substituted for the RSU 38, for example, a computer 12.

RSU 38 may include a processor and/or microprocessor 200 configured 520 to process data, and execute the relevant code, instruction sets and subroutines of the alert process 10. Microprocessor 200 may be coupled via a storage adaptor (not shown) to one or more external storage device(s), and non-transient computer readable medium 30. An I/O controller 202 may couple microprocessor 200 with various devices, such as one or more sensor(s) 216, vehicle detection device 208, USB ports (not shown), wireless transmitter 218, and one or more wireless receiver(s) 206. A network controller/adaptor 214 (e.g., an Ethernet adaptor) may be configured to couple microprocessor 200 to a network 14, wherein the network 14 may be the Internet or a local area network. The one or more sensor(s) 216 may be configured 520 to receive 530 roadside data and vehicle data. The Microprocessor 200 may be coupled via an interface (not shown) to a wireless transmitter 218, and the wireless transmitter 218 may be configured 520 to transmit 560 an alert message to a mobile computing device 42 (not shown). The configuration 520 of the RSU 38 may be via a programming interface.

In some implementations, vehicle detection device 208 may be configured 520 to be passive in operation. The wireless transmitter 218 may include a configurable 520 wireless antenna beam pattern, and a configurable 520 transmit power level. The wireless transmission may further be a sub 1 GHz transmission. The Microprocessor 200 may be coupled via the network controller/adapter 214 to a roadside infrastructure network, wherein the roadside infrastructure network includes a roadside infrastructure database located on a server (not shown). In some instances the mobile computing device 42 may include a roadside infrastructure database. The RSU 38 may include one or more wireless receivers 206, wherein the one or more wireless receivers 206 are configured 520 to receive 530 roadside data, Global Positioning System (GPS) data and vehicle data.

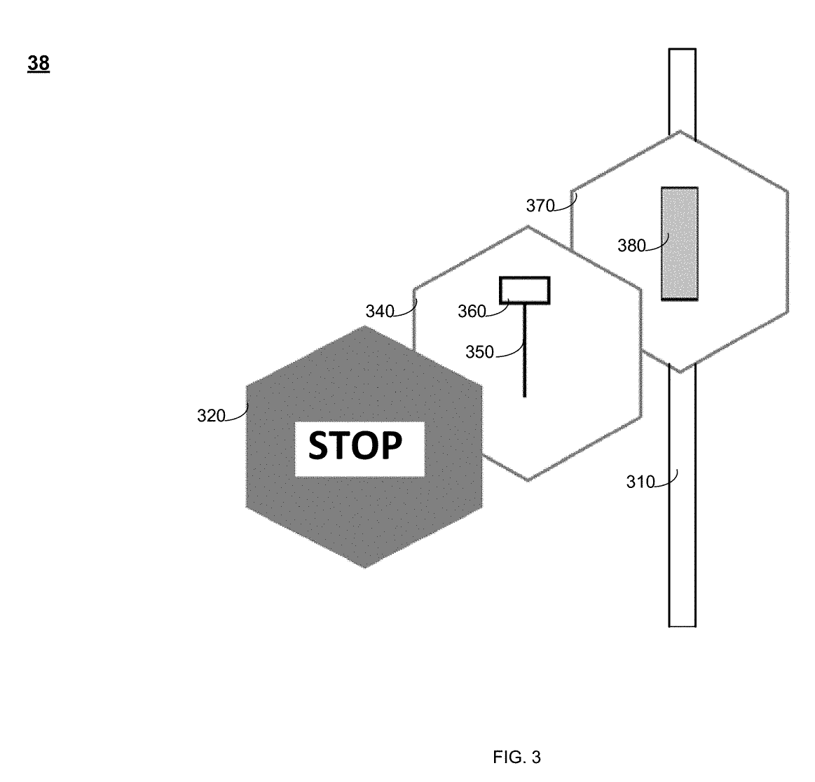

Referring also to FIG. 3, there is shown a diagrammatic view of RSU 38, wherein the RSU 38 is integrated into a sign 312. The sign 312 may have a composite construction, wherein the composite construction includes a plurality of discrete layers 320, 340 and 370, wherein each layer may perform one or more discrete function(s). For example, the middle layer 340 may include a printed circuit board (PCB) 360, which mechanically supports, and electrically connects the electrical components of the RSU 38. Further, the PCB 360 may be a multi-layer PCB (not shown), wherein the multi-layers are connected with plated-through holes or via(s).

In some implementations, the either middle layer 340 and/car an additional layer (not shown) may further include, one or more wireless antenna(s) 350. Further, either the middle layer 340 and/or the additional layer may include an integrated battery (not shown). The integrated battery may use a battery technology, such as a lithium ion or lithium polymer, which may be manufactured into one or more thin flat layer(s), wherein the thin flat layers facilitate the layered construction of the sign 312. The integrated battery may further be rechargeable. The RSU 38 may be powered by one or more of, the integrated battery, an external battery, a solar array and a power grid.

In one implementation, the sign 312 may further include a front layer 320, wherein the front layer 320 may include or may be a mask, wherein the mask may include regulatory data, for example, “STOP”. The mask may be digitally printed, wherein the digital printing uses a retroreflective printing material.

In another implementation, the sign 312 may further include a back layer 370, Wherein the back layer 370 may be configured as an antenna reflector 380 or include an integrated antenna reflector 380, alternatively there may be a separate antenna reflector 380 (not shown). The antenna reflector 380 may be designed to reflect electromagnetic waves, for example, the antenna reflector 380 may be configured as quarter wavelength radius antenna, wherein the quarter wavelength construction may provide constructive interface. The constructive interference may further increase the antenna 350 gain, and therefore the effective transmission distance of the RSU 138 wireless transmitter 218. One or more, of the front layer 320, and back layer 370 may be configured as a solar array (not shown). The RSU 38 may include a GPS (not shown), and one or more of, the front layer 320, the middle layer 340, and the back layer 370, may be configured as a GPS antenna or incorporate a GPS antenna.

In some implementations the RSU 38 may be encapsulated in a weatherproof enclosure (not shown). The weatherproof enclosure, may further be inconspicuous and vandal proof. The weatherproof enclosure may be coupled to existing infrastructure, and regulatory signs 312 (signposts), using one or more universals mount (not shown).

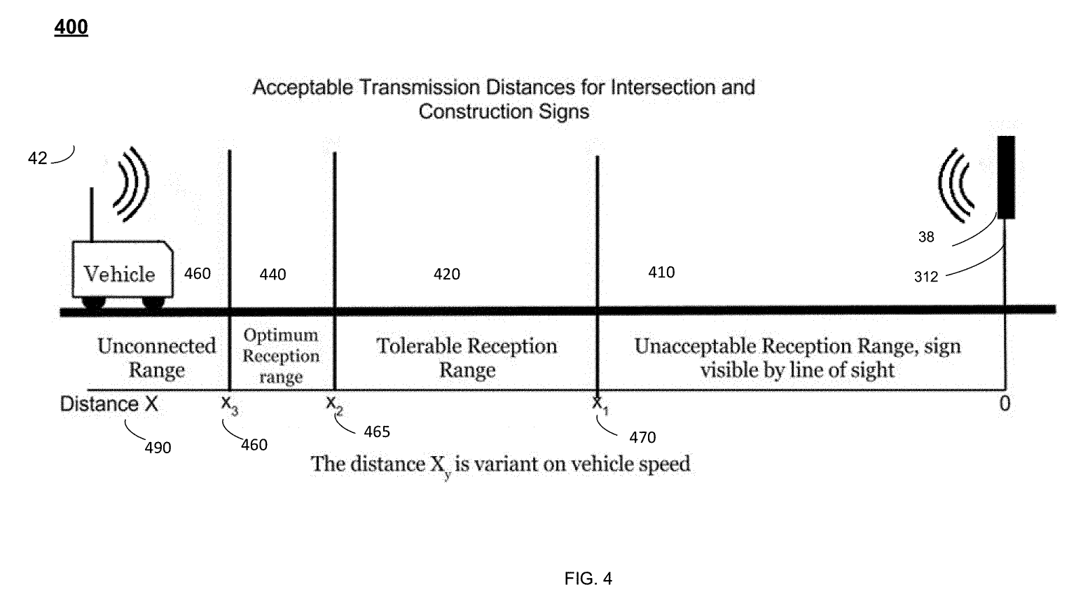

Referring also to FIG. 4, there is shown a diagrammatic view of RSU 38, and zones 410, 420, 430, 440 and 460. The RSU 38 may be integrated into a sign 312, or an encapsulated RSU 38 may be coupled to an existing sign 312 or placed a distance 490 from the existing sign 312. The distance 490, may ensure that a RSU 38 and/or vehicle 42, are detected 540 at an optimum range 460 from the existing regulatory sign 312. The optimum range 460 may be determined by one or more of, the geographical location(s), the anticipated speed of vehicles 42, government regulations, the visibility of existing infrastructure and regulatory sign 312, analysis of roadside accidents, and average reaction times of drivers. For example, without suitable placement the RSU 38 may not be detected 540 until the mobile computing device 42 is within an unacceptable reception range 470, wherein the range may be unacceptable because, it does not comply with government regulatory requirements or allow sufficient time for a driver to react. Under these circumstances it may be necessary to modify the detection range, by one or more of, configuring the wireless antenna 218 beam pattern, modifying the transmitter 218 power level, physically relocating a RSU 38 further from the existing regulatory sign 312, such that the notification distance, with respect to the existing regulatory sign 312 is increased.

Referring again to FIG. 4, the notification distance may be broken down into a number zones 410, 420, 440 and 460, wherein the various zones are described with respect to an existing regulatory sign 312 as an illustrative example. Within zone 410, the notification distance may be unacceptable, because it does not comply with regulatory requirements. Within zone 440, the notification distance may be optimum because it complies with regulatory conditions, and allows sufficient time for the driver of the vehicle 42 to reaction to the road conditions. Within zone 420, the notification distance may be neither optimum 440 or unacceptable 410. Within zone 460, the distance may be such that it may not be possible for the RSU 38 to be detected 540 or the vehicle 42 to be detected 540. In some implementations the notification distance, and thereby the size of the zones 410, 420, 440 and 460, from the existing sign 312 may be static in nature. In other implementations, the notification distance 460 may be dynamic and modified in real-time. The RSU 38 may include one or more sensor (s) 216, and the notification distance 460 may modified based, at least in part, upon the one or more sensor(s) 216 readings. For example, the notification distance, may depend upon on the vehicle 42 speed, time of day, for example a school zone, the local visibility, local weather condition and road conditions.

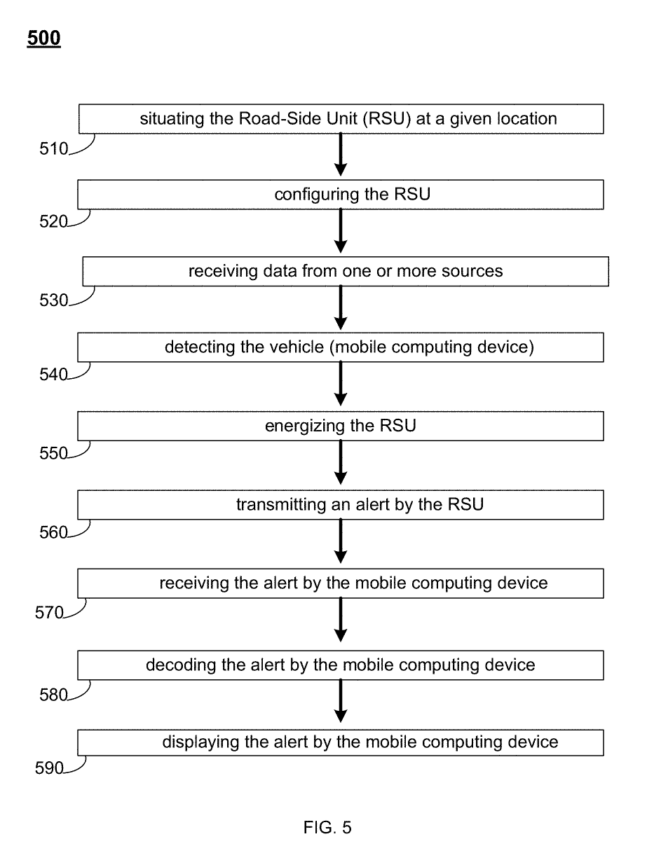

FIG. 5 illustrates a flowchart for a method 500 for a transmitting an alert from a RSU 38 to a mobile computing device 42, wherein the mobile computing device may be associated with a vehicle or person. In some instances the alert may include environmental data, regulatory data, hazard and congestion warning data, pertaining to one or more geographical locations and data pertaining to the vehicle. It should be understood that while method 500 indicates a particular order of execution of operations, in some instances, certain portions of the operations may be performed in a different order, and on different systems. Further, in some other instances, additional operations or steps may be added to method 500. Similarly, some operations or steps may be omitted from method 500.

At block 510 the RSU 38 may be situated 510 at a given location. For example, the RSU 38 may be integrated into a “STOP” sign 312, and the STOP sign 312 may be place at an intersection. The RSU 38 may be encapsulated in a weatherproof enclosure, wherein the RSU 38 is affixed to an existing sign 312 or infrastructure using one or more universal mounts. Alternatively, the RSU 38 may be situated 510 a notification distance from the existing sign 312, wherein the notification distance facilitates an optimum reception range 460. Situating 510 the RSU 38 may include coupling the RSU 38 to an external power source. Situating 510 the RSU 38 may also include coupling the RSU 38 to a roadside infrastructure communication network, wherein the roadside infrastructure network includes a roadside infrastructure network database located on a server.

At block 520 the RSU 38 may be configured 520. For example, the RSU 38 may be configured 520 via a programming interface as a “STOP” sign 312 or as “YIELD” sign 312. Further, the RSU 38 may include a configurable wireless antenna 218 beam pattern, and a programmable transmit power level, wherein the wireless antenna 218 beam pattern, and the programmable transmit power level may be configured 520 for a given location, thereby ensuring an optimum reception range 460. The configuration 520 of the RSU 38 may allow for communication between the RSU 38 and the mobile computing device 42, referred to as R2V communication, wherein the R2V communication may be, or may form part of, a roadside infra-structure communication network. The roadside infrastructure communication network may include a roadside infrastructure communication network database located on a server. In some instances, a roadside infrastructure network database may be located on the mobile computing device 42. The configuration 520 of the RSU 38 may include configuration 520 of an alert, wherein the alert is transmitted from the RSU 38 to the mobile computing device 42. For example, the configuration 520 of the alert may include one or more of, environmental data, regulatory data hazard and congestion warning data, pertaining one or more geographical locations, and data pertaining to the vehicle 42 or to a person. Further, the RSU 38 may be associated with one or more business applications. For example, the RSU 38 may be programmed, and thereby configured 520, with data pertaining to one or more business applications, wherein the business applications may include location data, services and hours of operation.

At block 530 the RSU 38 may receive 530 data from one or more sensor(s) 216, wherein the one or more sensor(s) 216 are configured 520 to collect environmental data, and data pertaining to the vehicle 42. The RSU 38 may receive 530 wireless data transmitted from the mobile computing device 42. The RSU 38 may receive 530 location, and time data from a GPS unit. Further, if the RSU 38 is associated with a person or vehicle 42 then the GPS location data associated with the RSU 38 may need to be updated on a more regular basis than GPS location data associated with a sign 312 or infrastructure. The GPS location data update rate may therefore be dependent on a specific application, which the RSU 38 may determine from its configuration 520. The RSU 38 may receive 530 one or more of, environmental data, regulatory data, hazard and congestion warning data, pertaining one or more geographical locations and data pertaining to the vehicle, from the roadside-infrastructure network or the detected vehicle 42.

At block 540 the RSU 38 may detect 540 the mobile computing device 42, wherein the mobile computing device 42 may be associated with a vehicle 42, such as an automobile 42 or bicycle 42. The mobile computing device 42 may be a mobile phone 42, an in-dash vehicle information console 42, or a standalone road-side alert device 42, with similar utility to a standalone GPS unit. The mobile computing device 42 may receive 530 the alert, process 580 the alert, and display 590 the alert.

At block 550 the RSU 38 may be energized 550 based, at least in part, upon detecting 540 the mobile computing device 42 or upon detection 540 of the vehicle 42, wherein the RSU 38 may be configured 520 to be in a ultra-low power mode or standby prior to being energized 550. The detection 540 may occur as a result of receiving 530 data from one or more sensor(s) 216. Further, the detection 540 may occur in response to a receipt 570 of one or more wireless messages from the mobile computing device 42, wherein the RSU 138 listens for one or more wireless messages originating from the mobile computing device 42 or vehicle 42. The RSU 38 may further process 580 data received. 530 from one or more of, the one or more sensor(s) 216, the mobile computing device 42, GPS sensor(s) 216 and the roadside-infrastructure network. For example, the RSU 138 may determine the vehicle 42 type, number of vehicles 42, the amount of time the vehicle 42 remains within a given location, and the average speed of a vehicle 42. The RSU 38 may further, store this cognitive data, wherein the cognitive data may be stored within the non-transitory memory of the RSU 38, and within a server coupled to the roadside-infrastructure network.

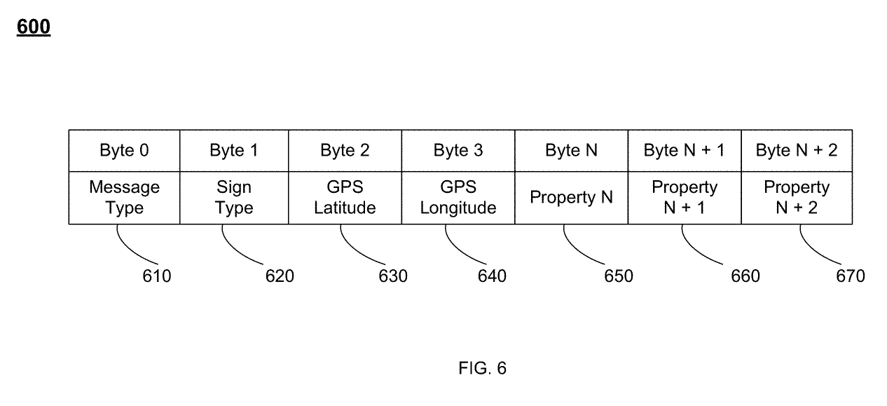

At block 560 the RSU 38 may transmit 560 an alert to the mobile computing device 42. The alert may be transmitted 560 after the RSU 38 has been energized 550. The alert may be transmitted 560 in response to the detection 540 of the mobile computing device 42 or upon detection 540 of the vehicle 42. The alert may be transmitted 560 in response to a message received 530 from the mobile computing device 42 or vehicle 42. The alert may be a roadside alert message, wherein the message format of the roadside alert message is a dedicated short range communication message or a propriety message format as described below with respect to FIG. 6.

Further, the alert may be based, at least in part, upon environmental data, regulatory data, hazard and congestion warning data, pertaining to one or more geographical locations and data pertaining to the vehicle 42. In one implementation, the RSU 38 may determine whether to transmit 560 the alert based, at least in part, upon one of, the received 530 signal strength of the detected 540 message, the location of the vehicle 42, the temporal proximity and the spatial proximity of the vehicle 42. The RSU 38 may therefore be configured 520 to operate in an optimum range 440, wherein the optimum range 440 may ensure that there is sufficient time for either the operator of a vehicle 42 or an autonomous vehicle 42 to make an appropriate response. The optimum range 440 may be defined as a distance 465 from the RSU 38 to the furthest distance 460 that the RSU 38 may reliability communicate with the mobile computing device 42. The optimum range 440 may further be used to ensure that the mobile computing device 42 receives alerts that are relevant, and may thereby eliminate alerts that may be useless, and therefor distracting.

At block 570 the alert may be received 570 by the mobile computing device 42. The mobile computing device 42 may be one of, a mobile phone 42, an in-dash vehicle information console 42, and a dedicated roadside alert device 42, wherein the dedicated roadside alert device may have utility similar to that of a standalone GPS unit

At block 580 the mobile computing device 42 may decode 580 the alert, wherein the decoding 580 may include security authentication and decryption. The decoding 580 of the alert may entail the use of a lookup table, and a roadside infrastructure database, wherein the lookup table and the roadside infrastructure database may increase the decoding efficiency. Decoding may include filtering the alerts, wherein the alerts may be filtered based on a driving situation, a specific driving related objective or mode of operation. For example, in the case of highway driving only those alerts pertaining to highway driving may be displayed 590, such as those alerts pertaining to highway construction, highway speed limits, approaching exits and diversions. In the case of a specific driving related objective, such as finding a parking space, only those alerts associated with finding a parking space may be displayed 590, or these alerts may be given greater prominence or emphasis in comparison to other alerts. In the case of a mode of operation, such as navigation only those alerts pertaining to the navigation route, and coverage zone of the alerts may be displayed 590.

At block 590 the mobile computing device 42 may display 590 the alert, wherein the display 590 is one of, the display 590 of a mobile phone 42, the display 590 of an in-dash vehicle information console 42, and the display 590 of a dedicated roadside device 42. The alert may be associated with one or more audio alerts, and visual cues. The visual cues may include pictorial representations of the alert, and associated infrastructure and signs 312. The visual cues may further include pictorial representations of geographical areas or zones to which the alert is pertinent to. For example, an audio alert may sound, and a visual alert may be displayed 590 when the vehicle 42 is approaching a school zone. School zones may be displayed 590, and the mobile computing device 42 may be alerted when the mobile computing device 42 is within the school zone.

FIG. 6 illustrates a diagrammatic view of an alert message structure, wherein the alert message structure may include a plurality of bytes with specific functions or attributes. For example, within the alert message may be one or more bytes pertaining one or more of, environmental data, regulatory data, hazard and congestion warning data, wherein the aforementioned data may pertain to one or more geographical locations. Within the alert message structure there may be one or more bytes pertaining to the detected vehicle 42. For example, there may be one or more bytes pertaining to the speed of the detected vehicle 42 or a designated speed recommendation for the vehicle 42. Further, there may be one or more bytes pertaining to the temporal proximity, and spatial proximity, of the detected vehicle 42 with respect to other vehicles 42 or objects. For example, there may be bytes pertaining to collision or congestion avoidance. Further, there may be one or more bytes, pertaining to the location of the detected vehicle 42, an object or a service. For example, there may be bytes pertaining to the monitoring lane of departures or the location of a service or geographical location.

Further, the alert message may include one or more byte(s) pertaining to the identification of a RSU or a type of RSU. For example, one or more byte(s) may uniquely identify a specific RSU 38 or type of RSU 38, such as “STOP” sign 312. Furthermore, the “STOP” sign 312 may be designated by a unique identifier, wherein the unique identifier may include, but is not limited to, an alpha character string, a numeric character string, a bit pattern, a binary numeral, an ASCII code, an integer, one or more raw bits, etc., or combinations thereof. The use of a unique identifier may reduce the amount of data need to represent a specific RSU 38, type of RSU 38 or an alert message. The unique identifier may be a form or data compression, and may be used with other wireless data compression techniques.

The use of data compression may reduce the amount of power needed by the RSU 38, which may be battery powered, to transmit the unique identifier. Data compression may further reduce the hardware cost associated with processing, storing and transmitting the unique identifier. Data compression may further increase the unique identifier transfer speed, and may reduce the system bandwidth.

The mobile computing device 42 may include a roadside infrastructure network database, which may include a lookup table. The lookup table may be used to decode the unique identifier associated with each RSU 38 type and alert message. The use of a lookup table may reduce the system message size, and the amount of processing power required by the mobile computing device to decode an alert message. In one implementation the RSU 38 may contain a lookup table, wherein utilization a lookup data may reduce the size of system messages transmitted to the RSU 38 by the mobile computing device 42. The lookup table may also reduce the processing power required by the RSU 38 to decode these messages, which may reduce the hardware cost and power consumption of the RSU 38.

Furthermore, the alert message may include one or more byte(s) pertaining to a geographical location. For example, the message may include bytes that identify a GPS latitude and a GPS longitude. There may also be more than one message type. For example, there may be message types that are regulatory, and there may also be informative messages, wherein the informative message contains data pertaining to a business or service. There may be diagnostic messages, wherein the diagnostic message reports the status of the RSU 38. There may be transit analytic messages, wherein the transit analytic message may contain cognitive data that may have been collected by the RSU 38. All of the aforementioned message types may be uniquely identified by one or more bytes within the alert message.

Referring to FIG. 6, the alert message may include a plurality of bytes with specific functions or attributes. For example, byte 0 610 may identify the message type, for example informative or diagnostic. Byte 1 620 may identify the sign 312 type, for example a “STOP” sign 312, a speed limit “30” sign 312 or a construction sign 312. Byte 2 630 may pertain to a GPS latitude, and byte 3 640 may pertain to a GPS longitude. There may also be N 650 proprietary or property data bytes 650, wherein the N data bytes 650 may include data pertaining to environmental data, regulatory data, hazard and congestion warning data, pertaining to one or more geographical locations, and data pertaining to the vehicle. There may further be a byte N+1 660, wherein the N+1 byte 660 may be a message identification number or party check byte. Byte N+2 670 may be a cyclic redundancy check byte.

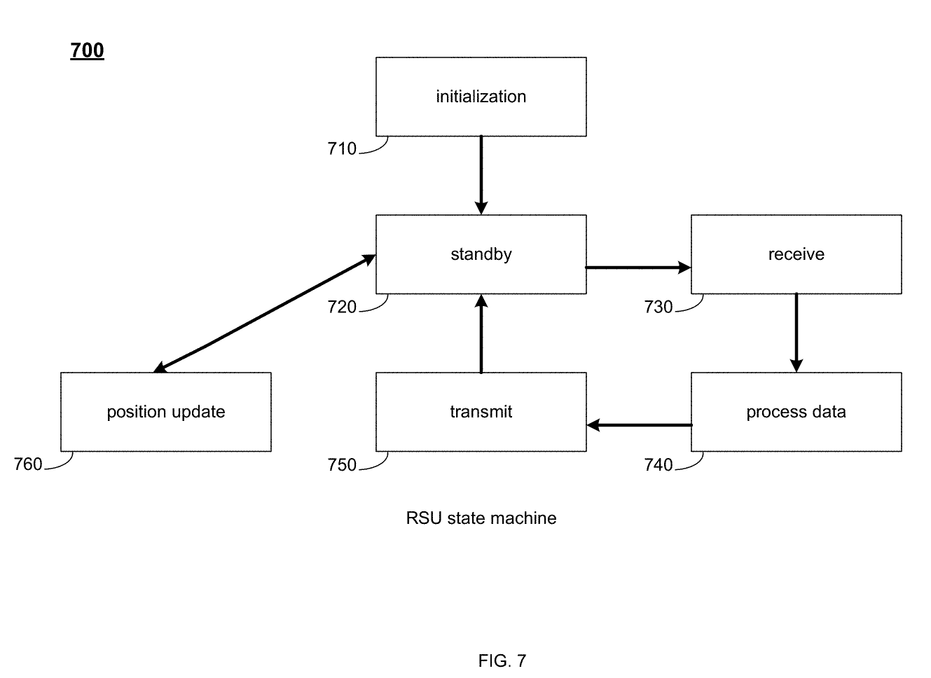

FIG. 7 is an illustrative diagrammatic view of a RSU 38 state machine. The 38 state machine may describe the system behavior of the RSU 38, and may include a finite number of discrete states. For example, “initialization” 710, “standby” 720, “receive” 730, “process data” 740, “transmit” 750, and “position update” 760. The RSU 38 state machine may be used to control the behavior of the RSU 38, and may perform actions in response to a specific event or input.

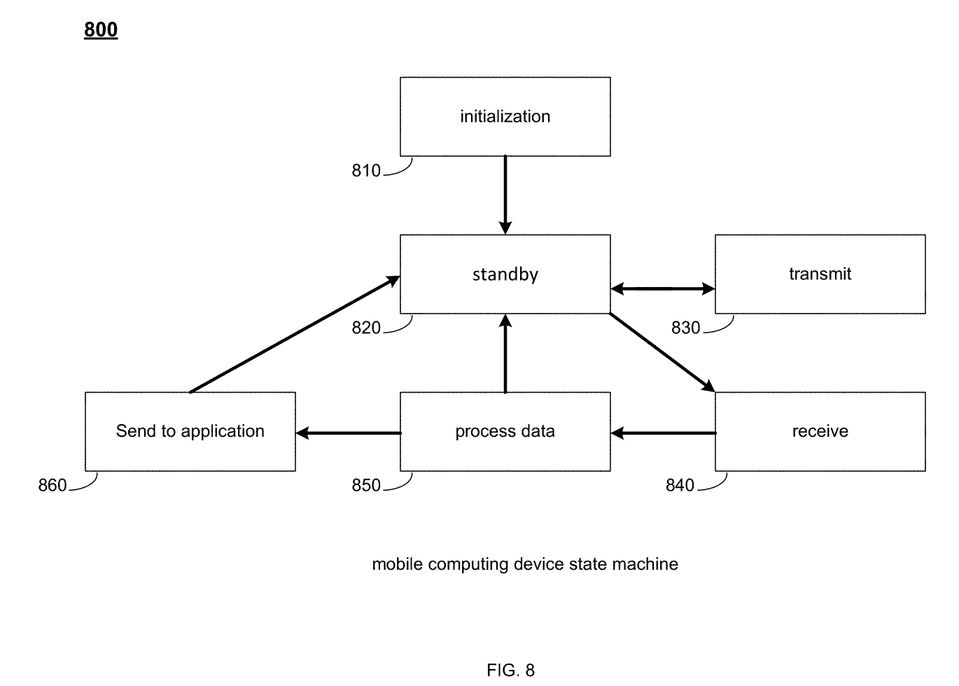

FIG. 8 is an illustrative diagrammatic view of a mobile computing device state machine 42. The mobile computing device 42 state machine may describe the system behavior of the mobile computing device 42, and may include a finite number of discrete states. For example, “initialization” 810 “standby” 820, “transmit” 830, “receive” 840, “process data” 850, and “send to application” 860. The mobile computing device 42 state machine may further be used to control the behavior of the mobile computing device 42, and may perform actions in response to a specific event or input.

Referring again to FIG. 1, Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of alert process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); a read-only memory (ROM); an erasable programmable read-only memory (EPROM); and a Flash memory.

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Alert process 10 may be a component of the data store, a stand-alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a alert application (e.g., alert application 20). Alert process 10 and/or alert application 20 may be accessed via client applications 22, 24, 26, 28. Alert process 10 may be a standalone application, or may be an applet/application/script/extension that may interact with and/or be executed within alert application 20, a component of alert application 20, and/or one or more of client applications 22, 24, 26, 28. Alert application 20 may be a standalone application, or may be an applet/application/script/extension that may interact with and/or be executed within alert process 10, a component of alert process 10, and/or one or more of client applications 22, 24, 26, 28. One or more of client applications 22, 24, 26, 28 may be a standalone application, or may be an applet/application/script/extension that may interact with and/or be executed within and/or be a component of alert process 10 and/or alert application 20. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a RSU 38, a personal computer (e.g., client electronic device 38), a laptop computer (e.g., client electronic device 40), a smart/data-enabled, cellular phone (e.g., mobile computing device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of alert application 20 (and vice versa). Accordingly, alert application 20 may be a purely server-side application, a purely client-side application, or a hybrid server-side/client-side application that is cooperatively executed by one or more of client applications 22, 24, 26, 28 and/or alert application 20. As one or more of client applications 22, 24, 26, 28, alert process 10, and alert application 20, taken singly or in any combination, may effectuate some or all of the same functionality, any description of effectuating such functionality via one or more of client applications 22, 24, 26, 28, alert process 10, alert application 20, or combination thereof, and any described interaction(s) between one or more of client applications 22, 24, 26, 28, alert process 10, alert application 20, or combination thereof to effectuate such functionality, should be taken as an example only and not to limit the scope of the disclosure.

Users 46, 48, 50, 52 may access computer 12 and alert process 10 (e.g., using one or more of client electronic devices 38, 40, 42, 44) directly through network 14 or through secondary network 18. Further, computer 12 may be connected to network 14 through secondary network 18, as illustrated with phantom link line 54. Alert process 10 may include one or more user interfaces, such as browsers and textual or graphical user interfaces, through which users 46, 48, 50, 52 may access alert process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Mobile Computing device 42 is shown wirelessly coupled 70 to RSU 38. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Mobile computing device 42 is shown wirelessly coupled to network 14 via wireless communication channel 60 established between mobile computing device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. The short-range wireless connection may include one or more proprietary wireless interfaces and/or protocols. Other forms of interconnection (e.g., Near Field Communication (NFC)) may also be used.

As will be appreciated by one skilled in the art, aspects of the present disclosure may be implemented as a system, method or computer program product. Accordingly, aspects of the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present disclosure may take the form of a computer program product implemented in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The implementation was chosen and described in order to best explain the principles of the disclosure and the practical application, and to enable others of ordinary skill in the art to understand the disclosure for various implementations with various modifications as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A roadside alert system comprising:
at least one processor device; and
at least one memory architecture coupled with the at least one processor device;
wherein the at least one processor device is further configured to perform operations comprising;
detecting at a Road-Side Unit (RSU) a vehicle;
transmitting an alert from the RSU, upon detecting the vehicle, to a mobile computing device associated with the vehicle; and
allowing communication between one of, the RSU, the mobile computing device, and a roadside infrastructure communication network, wherein the roadside infrastructure communication network includes a roadside infrastructure network database located on a server and the mobile computing device, wherein the roadside infrastructure database includes a lookup table.

2. The roadside alert system of claim 1 wherein transmitting the roadside alert includes:
configuring a wireless antenna beam pattern; and
programming a transmit power level.

3. The roadside alert system of claim 1 further comprising:
configuring a RSU based, at least in part, upon environmental data, regulatory data, hazard and congestion warning data, pertaining to one or more geographical locations and data pertaining to the vehicle.

4. The roadside alert system of claim 1 further comprising:
monitoring one or more sensor(s), wherein the one or more sensor(s) are configured to collect roadside data and vehicle data; and
receiving roadside data and vehicle data from at least one of the one or more sensor(s), the mobile computing device, and the roadside infrastructure communication network.

5. The roadside alert system of claim 1 further comprising:
generating a mobile computing device message;
transmitting the mobile computing device message to the RSU, wherein the mobile computing device message is periodically transmitted.

6. The roadside alert system of claim 1 wherein the mobile computing device is one of, a mobile phone, an in-dash vehicle information console and a dedicated roadside alert device, wherein the mobile computing device receives, processes and displays the roadside alert.

7. A Road-Side Unit (RSU) comprising:
a processor;
a non-transient computer readable medium;
a vehicle detection device;
one or more sensor(s), wherein the one or more sensor(s) are configured to collect roadside information and vehicle data; and
a wireless transmitter, wherein the wireless transmitter is configured to deliver an alert to a mobile computing device associated with the vehicle.

8. The RSU of claim 7 wherein the vehicle detection device is configured to be passive in operation.

9. The RSU of claim 7 wherein the wireless transmitter includes a configurable wireless antenna beam pattern and a programmable transmit power level.

10. The RSU of claim 7 further comprising a roadside infrastructure network, wherein the roadside infrastructure network includes a roadside infrastructure database located on a server and on the mobile computing device, wherein the roadside infrastructure database includes a lookup table.

11. The RSU of claim 7 further comprising one or more receivers, wherein the one or more receivers are configured to receive roadside data, Global Positioning System (GPS) data and vehicle data.

12. The RSU of claim 7 further comprising a programming interface, wherein the RSU is configured via the programming interface.

13. The RSU of claim 7 wherein the RSU is associated with a PCBA (Printed Circuit Board Assembly), wherein the PCBA is incorporate into a sign.

14. The RSU of claim 13 wherein the sign includes an antenna reflector, wherein the antenna reflector is configured as a quarter wavelength antenna reflector.

15. The RSU of claim 13 wherein the PCBA is encapsulated in a weatherproof enclosure, wherein the weatherproof enclosure is configured to be attached to an existing sign or located a notification distance from the existing sign.

16. A computer-implemented method comprising:
detecting at a Road-Side Unit (RSU) a vehicle;
energizing a RSU based, at least in part, upon detecting the vehicle; and
transmitting an alert from the RSU to a mobile computing device associated with the vehicle, wherein the alert is based, at least in part, upon environmental data, regulatory data, hazard and congestion warning data, pertaining to one or more geographical locations and data pertaining to the vehicle, wherein transmitting the alert includes configuring a wireless beam pattern, and programming a transmit power level.

17. The computer-implemented method of claim 16 further comprising:
allowing communication between one of, the RSU, the mobile computing device, and a roadside infrastructure communication network, wherein the roadside infrastructure communication network includes a roadside infrastructure network database located on a server and on the mobile computing device, wherein the roadside infrastructure database includes a lookup table.

18. The computer-implemented method of claim 16 further comprising:
monitoring one or more sensor(s), wherein the one or more sensor(s) are configured to collect environmental data and data pertaining to the vehicle.

19. The computer-implemented method of claim 18 further comprising:
receiving roadside data and vehicle data from at least one of the one or more sensor(s), the mobile computing device, and the roadside infrastructure communication network.

20. The computer-implemented method of claim 16 wherein the mobile computing device is one of a mobile phone, an in-dash vehicle information console and a dedicated Road-Side Alert device, wherein the mobile computing device receives, processes and displays the alert.
